(19) United States
(12) Patent Application Publication
(10) Pub. No.: US 2014/0146728 A1
(43) Pub. Date: May 29, 2014

(54) METHOD AND APPARATUS FOR MANAGING LOW-DUTY MODE OPERATION

(71) Applicant: Electronics and Telecommunications Research Institute, Daejeon (KR)

(72) Inventors: Jae Sun CHA, Daejeon (KR); Eunkyung KIM, Daejeon (KR); Anseok LEE, Daejeon (KR); Wooram SHIN, Daejeon (KR); Kwang Jae LIM, Daejeon (KR)

(73) Assignee: Electronics and Telecommunications Research Institute, Daejeon (KR)

(21) Appl. No.: 14/067,412

(22) Filed: Oct. 30, 2013

(30) Foreign Application Priority Data
Nov. 27, 2012 (KR) 10-2012-0135037
Oct. 30, 2013 (KR) 10-2013-0129876

(51) Int. Cl. H04W 52/02

(52) U.S. Cl. CPC H04W 52/0206
USPC 370/311

(57) ABSTRACT

A method of managing a low-duty mode operation is provided by a small base station. The small base station determines a low-duty cycle pattern in which an available interval for data traffic transmission on active air interface and an unavailable interval for transmitting no data traffic are repeated, and provides a terminal with low-duty cycle pattern information. The low-duty cycle pattern information includes a length of the available interval and a start offset indicating a wireless frame at which the low-duty cycle pattern starts.

### CROSS-REFERENCE TO RELATED APPLICATION

This application claims priority to and the benefit of Korean Patent Application Nos. 10-2012-0135037 and 10-2013-0129876 filed in the Korean Intellectual Property Office on Nov. 27, 2012 and Oct. 30, 2013, the entire contents of which are incorporated herein by reference.

### BACKGROUND

(a) Field

The present invention generally relates to a method and apparatus for managing a low-duty mode operation.

(b) Description of the Related Art

A small base station is a base station for managing a small coverage compared with a macro base station. The small base station improves a communication quality in an area where the macro base station does not cover and shares a load of the macro base station. The small base station is installed within the coverage of the macro base station or on a boundary area of the macro base station to save the communication cost.

However, the small base station may generate interference on the macro base station such that the performance of a terminal on the boundary between the macro base station and the small base station can be deteriorated. A low-duty mode has been defined for reducing the interference between the macro base station and the small base station and conserving the power consumption of the small base station. The low-duty mode may be referred to as a duty-cycled mode.

The small base station enters the low-duty mode when no terminal exists within the coverage of the small base station or all terminals within the coverage of the small base station are in an idle state. The low-duty mode has a low-duty cycle pattern in which an available interval and an unavailable interval are repeated in turn. A low-duty mode operation of the small base station is performed according to the predefined low-duty cycle pattern. The small base station is active on an air interface for data traffic transmission in the available interval, and does not transmit any data traffic on the air interface in the unavailable interval. Therefore, during the unavailable interval, the interference to neighbor base stations can be reduced, and the power consumption of the small base station can be conserved.

The small base station has one default low-duty cycle pattern, and the available interval and unavailable interval with fixed sizes are repeated. In order to prevent the activated low-duty mode operation of the small base station from affecting a paging operation of an idle mode terminal, actual available intervals of the small base station include the available intervals defined in the default low-duty cycle pattern and available intervals of a paging cycle supported by the small base station. However, the low-duty mode operation has been defined in light of the default low-duty cycle pattern and the paging cycle, but allocation and operation of the default low-duty cycle pattern is not defined.

Since the small base stations are densely installed within the coverage of the macro base station, interference between the small base stations occur as well as the interference between the macro base station and the small base station. However, the low-duty mode operation of the conventional art merely takes account of a relationship between the macro base station and the small base station such that the interference between the adjacent small base stations can be increased.

Further, according to the conventional art, the small base station enters low-duty mode only when no terminal exists in the small base station or terminals in the small base station are in the idle state. However, since the small base station installed in a city with a large transient population generally enters the low-duty mode late at night, it is difficult to reduce interferences at daytime in which many data traffics are required. Furthermore, when the small base stations having terminals in active state or sleep state are allowed to enter the low-duty mode, the interference between the macro base station and the small base station can be reduced, but the interference between the small base stations can be increased. For example, when two or more small base stations use the same low-duty cycle pattern, the available intervals are overlapped such that the interference to the neighbor small base station can be occurred.

### SUMMARY

An embodiment of the present invention provides a low-duty mode operation managing method and apparatus for mitigating interference between a macro base station and a small base station or interference between small base stations.

According to another embodiment of the present invention, a method of managing a low-duty mode operation is provided by a small base station. The method includes determining a low-duty cycle pattern in which an available interval for data traffic transmission on active air interface and an unavailable interval for transmitting no data traffic are repeated, and providing a terminal with low-duty cycle pattern information. The low-duty cycle pattern information includes a length of the available interval and a start offset indicating a wireless frame at which the low-duty cycle pattern starts.

In another embodiment, the low-duty cycle pattern may start at the wireless frame satisfying “(wireless frame number) mod (a length of the low-duty cycle pattern)=the start offset”.

In this case, the available interval of the low-duty cycle pattern may starts at the wireless frame number.

In another embodiment, the low-duty cycle pattern information may further include the length of the low-duty cycle pattern. Here, the length of the low-duty cycle pattern may be a sum of the length of the available interval and a length of the unavailable interval.

Alternatively, the low-duty cycle pattern information may further include a length of the unavailable interval.

In another embodiment, the low-duty cycle pattern information may further include a basic unit. Here, the length of the available interval may be represented as a multiple of the basic unit.

In this case, the basic unit may indicate an exponent when a number of wireless frames is represented as a power of 2.

In another embodiment, the method may further include, when the low-duty cycle pattern is changed, broadcasting a message including information about the changed low-duty cycle pattern.

According yet another embodiment of the present invention, a method of managing a low-duty mode operation is provided by a server managing a small base station. The method includes determining a low-duty cycle pattern in which an available interval for data traffic transmission on active air interface and an unavailable interval for transmitting no data traffic are repeated, for the small base station, and providing the small base station with low-duty cycle pattern information. The low-duty cycle pattern information includes a length of the available interval and a start offset indicating a wireless frame at which the low-duty cycle pattern starts.

In yet another embodiment, the low-duty cycle pattern may start at the wireless frame satisfying “(wireless frame number) mod (a length of the low-duty cycle pattern)=the start offset”.

In this case, the available interval of the low-duty cycle pattern may start at the wireless frame number.

In yet another embodiment, the low-duty cycle pattern information may further include the length of the low-duty cycle pattern

Here, the length of the low-duty cycle pattern may be a sum of the length of the available interval and a length of the unavailable interval.

Alternatively, the low-duty cycle pattern information may further include a length of the unavailable interval.

In yet another embodiment, the low-duty cycle pattern information may further include a basic unit. Here, the length of the available interval may be represented as a multiple of the basic unit.

In this case, the basic unit may indicate an exponent when a number of wireless frames is represented as a power of 2.

In yet another embodiment, determining the low-duty cycle pattern may include receiving information about neighbor base stations and location information of the small base station from the small base station, and determining the low-duty cycle pattern based on the information about neighbor base stations and the location information.

According to further embodiment of the present invention, an apparatus for managing a low-duty mode operation is provided, and the apparatus includes a controller and a transceiver. The controller determines a low-duty cycle pattern in which an available interval for data traffic transmission on active air interface and an unavailable interval for transmitting no data traffic are repeated. The transceiver provides a terminal with low-duty cycle pattern information. The low-duty cycle pattern information includes a length of the available interval and a start offset indicating a wireless frame at which the low-duty cycle pattern starts.

In further embodiment, the low-duty cycle pattern may start at the wireless frame satisfying “(wireless frame number) mod (a length of the low-duty cycle pattern)=the start offset”.

In further embodiment, the low-duty cycle pattern information may further include the length of the low-duty cycle pattern. In this case, the length of the low-duty cycle pattern may be a sum of the length of the available interval and a length of the unavailable interval.

Alternatively, the low-duty cycle pattern information may further include a length of the unavailable interval.

### BRIEF DESCRIPTION OF THE DRAWINGS

FIG. 1 shows a communication system according to an embodiment of the present invention.

FIG. 2A, FIG. 2B, and FIG. 2C show examples of low-duty cycle pattern allocations according to an embodiment of the present invention.

FIG. 3A, FIG. 3B, and FIG. 3C show examples of low-duty cycle patterns allocated to the small base station shown in FIG. 1.

FIG. 4 is a flowchart showing an allocation process of a low-duty cycle pattern in a low-duty mode operation managing method according to an embodiment of the present invention.

FIG. 5 is a flowchart showing a change process of a low-duty cycle pattern in a low-duty mode operation managing method according to an embodiment of the present invention.

FIG. 6 and FIG. 7 each is a block diagram showing a low-duty mode operation managing apparatus according to an embodiment of the present invention.

### DETAILED DESCRIPTION OF THE EMBODIMENTS

In the following detailed description, only certain embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. Like reference numerals designate like elements throughout the specification.

In the specification, the term “terminal” may designate a mobile terminal (MT), a mobile station (MS), an advanced mobile station (AMS), a high reliability mobile station (HR-MS), a subscriber station (SS), a portable subscriber station (PSS), an access terminal (AT), a user equipment (UE), and so on, or may include all or some functions thereof.

Further, the term “base station” (BS) may designate an advanced base station (ABS), a high reliability base station (HR-BS), a node B, an evolved node B (eNodeB), an access point (AP), a radio access station (RAS), a base transceiver station (BTS), an MMR (mobile multihop relay)-BS, and so on, or may include all or some functions thereof.

Furthermore, the term “small base station” may designate a femto BS, a home node B (HNB), a pico BS, a metro BS, a micro BS, and so on, or may include all or some functions thereof.

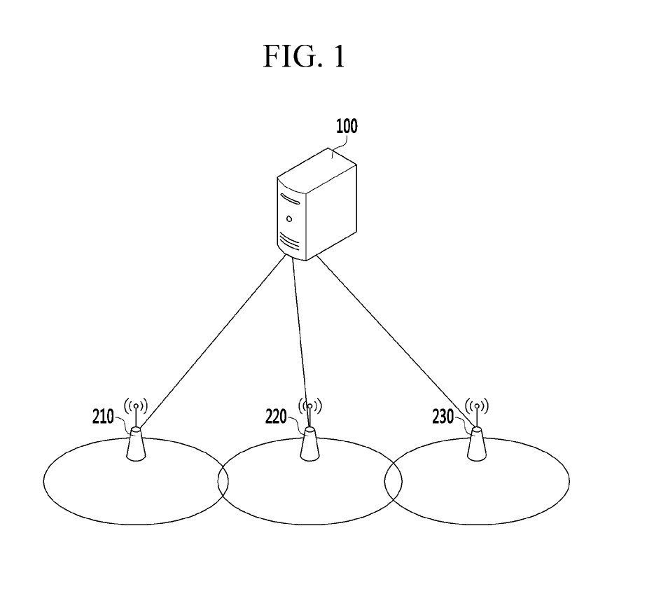

FIG. 1 shows a communication system according to an embodiment of the present invention.

Referring to FIG. 1, a low-duty operation management server 100 manages a plurality of small base stations 210, 220, and 230. In FIG. 1, the small base station 220 suffers interferences from the two small base stations 210 and 230, but the two small base stations 210 and 230 do not suffer from each other since they are geographically separated. The low-duty operation management server 100 manages allocation and change of low-duty cycle patterns for the small base stations 210, 220, and 230, and may be a self-organization (SON) server managing the self-organization of the small base station or a gateway server managing network access of the small base station.

The low-duty operation management server 100 determines a length of the low-duty cycle pattern based on at least one of the minimum data rate required by all small base stations which it manages, interferences from neighbor base stations to the small base station, user distribution of the small base station, a power saving requirement of the small base station, a type of the small base station, and a location of the small base station, and allocates the low-duty cycle patterns with the same length to the all small base stations.

Alternatively, when so many small base stations are installed within a network or various types of small base stations exists, the low-duty operation management server 100 may exceptionally allocate the low-duty cycle patterns with the different lengths. In this case, a threshold for the number of small base stations or a threshold for the number of types may be experimentally determined. Further, the low-duty operation management server 100 allocates the low-duty cycle patterns such that the lengths of the allocated low-duty cycle patterns become multiples of the length of the low-duty cycle pattern having the minimum length.

Table 1 represents a parameter for defining a low-duty cycle pattern according to an embodiment of the present invention.

TABLE 1

| Name | Description |
|---|---|
| Basic | A basic unit used to represent lengths of the available interval |
| Unit | and the unavailable interval. Basic Unit is the exponent when |
| | the number of wireless frames is represented as the power of |
| | 2. For example, Basic Unit with 2 represents 4 wireless |
| | frames. |
| Length of | Represents the length of the available interval |
| Available | Length of Available Interval is represented as the multiple of |
| Interval | basic unit. |
| Length of | Represents the length of the low-duty cycle pattern |
| Low-duty | Length of Low-duty Cycle Pattern is represented as the |
| Cycle | multiple of basic unit. |
| Pattern | |
| Start | Represents a start time of the available interval |
| Offset | The available interval starts at a wireless frame satisfying |
| | “(current wireless frame number) mod (length of low-duty |
| | cycle pattern) = Start Offset”. |

Referring to Table 1, the low-duty cycle pattern parameter includes a basic unit, a length of available interval, a length of low-duty cycle pattern, and a start offset. The available interval and the unavailable interval may be referred to as an active period and an inactive period, respectively.

The basic unit indicates a basic value for representing the length of the low-duty cycle pattern and the length of available interval. The basic unit denotes the number of wireless frames, and the wireless frame may be a frame or a superframe according to a system configuration. According to another embodiment, a value of the basic unit does not indicate the actual number of wireless frames, but may indicate the exponent when the number of wireless frames is represented as the power of 2. For example, when the basic unit representing the length of available interval and the length of low-duty cycle pattern is set to 3, the length of available interval and the length of low-duty cycle pattern are set as the multiple of 8 (=2³). As such, representing the lengths of low-duty cycle pattern and available interval as the multiples of the basic unit can minimize the overhead required when the small base station notifies a terminal of information about the low-duty cycle pattern.

The length of low-duty cycle pattern indicates a length of the low-duty cycle pattern including the available interval and the unavailable interval. The length of available interval indicates a length of an interval during which uplink/downlink transmission/reception is activated. The length of low-duty cycle pattern and the length of available interval are represented as the multiples of the basic unit. The length of available interval subtracted from the length of low-duty cycle pattern is the length of unavailable interval. According to another embodiment, the low-duty cycle pattern parameter may include, as information for determining the length of low-duty cycle pattern, the length of unavailable interval instead of the length of low-duty cycle pattern.

The start offset indicates a start offset (i.e., a start time) of the allocated low-duty cycle pattern, i.e., a start offset of the available interval, and is represented as the multiple of the basic unit. The available interval starts at a wireless frame satisfying Equation 1. The length used in Equation 1 is the actual number of wireless frames to which the basic unit is applied.

(Wireless frame number) mod (length of low-duty cycle pattern)=start offset Equation 1

According to another embodiment, the low-duty cycle pattern parameter may not include the basic unit. In this case, the length of available interval and the length of low-duty cycle pattern (or the length of unavailable length) may be represented as a wireless frame unit.

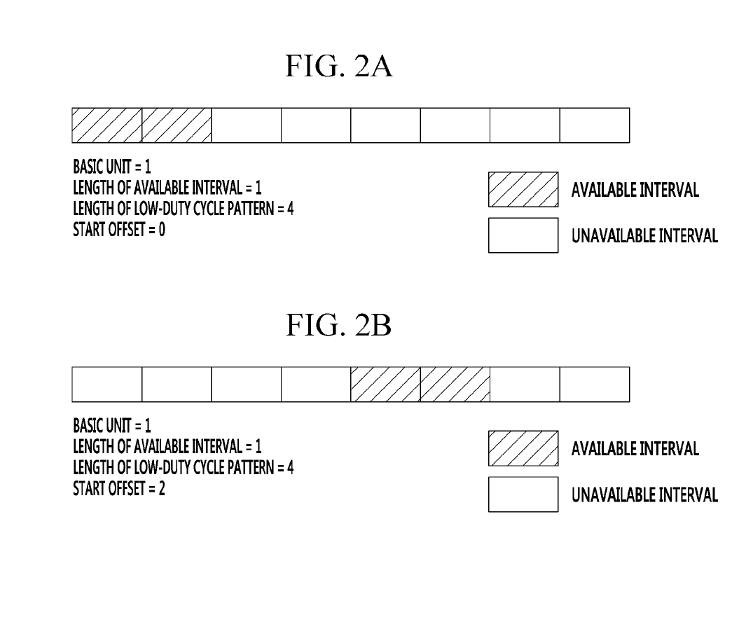

FIG. 2A, FIG. 2B, and FIG. 2C show examples of low-duty cycle patterns allocated according to an embodiment of the present invention.

The basic unit is set to 1 in FIG. 2A and FIG. 2B, and the basic unit is set to 2 in FIG. 2C. Therefore, the length of low-duty cycle pattern and the length of available interval are set as a unit of two frames in FIG. 2A and FIG. 2B, and the length of low-duty cycle pattern and the length of available interval are set as a unit of four frames in FIG. 2C.

Since the length of available interval is 1 and the length of low-duty cycle pattern is 4 in FIG. 2A, the length of available interval is two frames in the low-duty cycle pattern with eight frames. Because the start offset is set to 0, the available intervals start at wireless frames (wireless frames 0, 8, 16 . . . ) satisfying “(wireless frame number) mod 8=0”.

In FIG. 2B, the length of available interval is two frames in the low-duty cycle pattern with eight frames like FIG. 2A. Because the start offset is set to 2, the available intervals start at wireless frames (wireless frames 4, 12, 20 . . . ) satisfying “(wireless frame number) mod 8=4”.

Since the basic unit is 2, the length of available interval is 1, and the length of low-duty cycle pattern is 2 in FIG. 2C, the length of available interval is four frames in the low-duty cycle pattern with eight frames. Because the start offset is set to 1, the available intervals start at wireless frames (wireless frames 4, 12, 20 . . . ) satisfying “(wireless frame number) mod 8=4”.

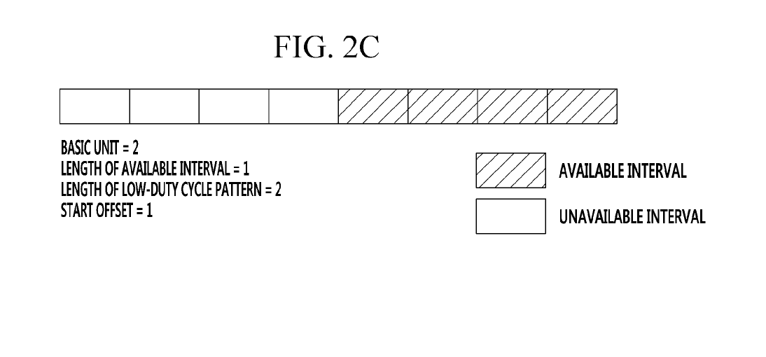

Referring to FIG. 1 again, the low-duty operation management server 100 determines the length of available interval and the start offset for each small base station based on installation locations of the small base stations and interferences to the small base stations. For example, the low-duty operation management server 100 may allocate low-duty cycle pattern parameters to the small base stations 210, 220, and 230 as shown in FIG. 3A, FIG. 3B, and FIG. 3C. It is assumed in examples of FIG. 3A, FIG. 3B, and FIG. 3C that low-duty operation management server 100 allocates the basic unit with 1 and the length of low-duty cycle pattern with 3 to the small base stations 210, 220, and 230.

Assuming requirements of the small base stations 210, 220, and 230 are the same, the available intervals with the same length are allocated to the small base stations 210, 220, and 230 in FIG. 3A, FIG. 3B, and FIG. 3C. However, the low-duty operation management server 100 allocates the different start offsets to the adjacent small base stations 210, 220, and 230 because the interferences are different in the small base stations 210, 220, and 230. Since the small base station 220 may suffer the interference from the small base station 210 and the small base station 230, the low-duty operation management server 110 allocates to the small base station 220 the start offset being different from the start offsets of the small base stations 210 and 220. However, since the small base stations 210 and 230 does not suffer from the interference from each other, the low-duty operation management server 110 allocates the same start offset to the small base stations 210 and 230. In the examples of FIG. 3A, FIG. 3B and FIG. 3C, the length of available intervals allocated to all the small base stations 210, 220, and 230 are 1, the start offset allocated to the small base station 220 is 0, and the start offsets allocated to the small base stations 210 and 230 are 1.

As such, because the low-duty cycle patterns with the same length are operated by using the different start offsets, both the interference between the macro base station and the small base station and the interference between the small base stations can be mitigated.

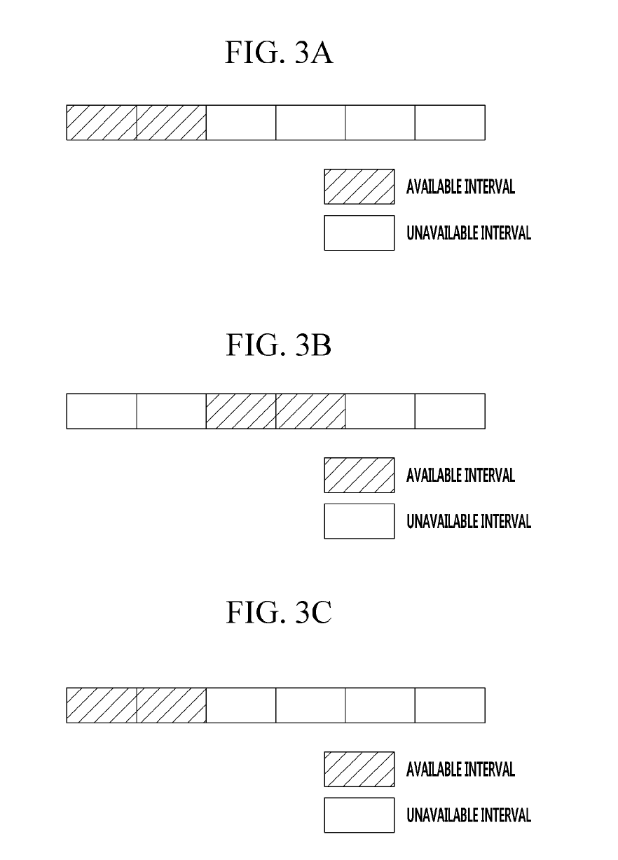

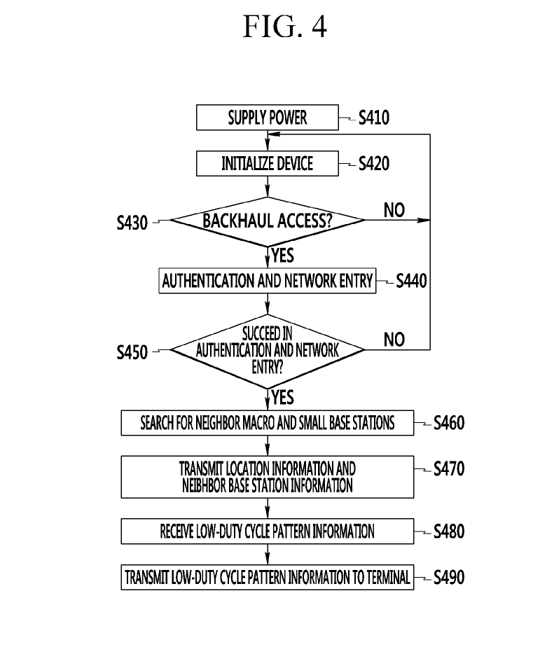

A method of managing a low-duty mode operation according to an embodiment of the present invention is described with reference to FIG. 4 and FIG. 5.

FIG. 4 is a flowchart showing an allocation process of a low-duty cycle pattern in a low-duty mode operation managing method according to an embodiment of the present invention.

Referring to FIG. 4, when a power is supplied to a small base station (S410), the small base station performs a device initialization (S420) and then determines whether it can perform a backhaul access (S430). When the backhaul access can be performed, the small base station performs an authentication and a network entry with a server managing the small base station, for example a low-duty operation management server, through the backhaul (S440). When succeeding in the authentication and the network entry (S450), the small base station searches for a neighbor macro base station and a neighbor small base station (S460). The small base station transmits information about the searched neighbor base stations and location information of the small base station to the low-duty operation management server (S470).

The low-duty operation management server determines a low-duty cycle pattern based on a type of the small base station, an installation location of the small base station, interference from the neighbor base stations, and/or a minimum data rate guaranteed by the small base station, and transmits the determined low-duty cycle pattern to the small base station (S480). The small base station received information about the low-duty cycle pattern activates a wireless interface and performs a normal operation.

Next, the small base station periodically broadcasts information about the low-duty cycle pattern operated by the small base station to terminals within the small base station through a broadcast message for transmitting system information (S490). According to another embodiment, the small base station may provide a terminal with the low-duty cycle pattern information while the terminal performs an initial network entry.

The small base station enters a low-duty mode when no terminal exists within its coverage or all terminals of the small base station are in an idle state. In addition, even if a terminal in an active state exists in the small base station, the small base station may enter the low-duty mode in accordance with a low-duty mode entry condition including at least one of the number of terminals attached to the small base station, interference strength from a neighbor macro base station or neighbor small base station, and a power saving requirement of the small base station. In this case, the small base station may determine whether to enter the low-duty mode through a negotiation with a server in the network, for example a low-duty operation management server.

Table 2 represents an example of a message that a small base station uses to transmit low-duty cycle pattern information to terminals within the small base station.

TABLE 2

| | Length | |
|---|---|---|
| Name | (byte) | Description |
| Message { | | |
| Length of Available | 1 | A length of the available interval |
| Interval | | represented as a multiple of a basic unit |
| Start Offset | 1 | Represents a start time of the |
| | | available interval |
| } | | |

Referring to Table 2, the message includes a length of available interval and a start offset as low-duty cycle pattern information which the small base station operates. The parameters included in the message are the same as the parameters defined in Table 1. However, when all small base stations within the network use low-duty cycle patterns with the same length, the message does not include the length of low-duty cycle pattern. Instead, a value that has been transferred at a network entry of the terminal or has been previously defined in a system may be used as the length of low-duty cycle pattern. Further, since the basic unit does not need to be periodically changed, the message does not include the basic unit. Therefore, the overhead for transmitting the low-duty cycle pattern information can be minimized.

Alternatively, when various basic units or various lengths of low-duty cycle patterns are used in the network, the message may include the basic unit or the length of low-duty cycle pattern (or the length of unavailable interval).

Table 3 represents low-duty cycle pattern information included in a neighbor base station information message.

TABLE 3

| | | |
|---|---|---|
| | Length | |
| Name | (byte) | Description |

```
Neighbor Base Station Information
Message {
  For (i=; i<Number of Neighbor Base
  Stations; i++) {
```

| Neighbor Base Station Identifier | | Represents an |
|---|---|---|
| | | identifier of neighbor |
| | | base station |
| Length of Available Interval | 1 | Represented as a |
| | | multiple of the |
| | | basic unit |
| Start Offset | 1 | Represents a start |

time of the
available interval

}

}

Referring to Table 3, the neighbor base station information message which a small base station transmits to terminals in the small base station includes a length of available interval and a start offset as low-duty cycle pattern information. However, since the neighbor base station information message includes information about the neighbor base stations, the neighbor base station information message includes low-duty cycle pattern informations which are operated by all neighbor small base stations to a serving small base station along with neighbor base station identifiers.

FIG. 5 is a flowchart showing a change process of a low-duty cycle pattern in a low-duty mode operation managing method according to an embodiment of the present invention.

Referring to FIG. 5, when a small base station which are performing a normal operation or a low-duty mode operation receives a change request of a low-duty cycle pattern from a server in the network, for example a low-duty operation management server (S510), the small base station performs a change process of the low-duty cycle pattern. The change request message of the low-duty cycle pattern transmitted by the low-duty operation management server includes information about a changed low-duty cycle pattern.

The low-duty operation management server may request the change of the low-duty cycle pattern when at least one condition is satisfied from among below conditions.

1. A condition that it is impossible to allocate to a newly installed small base station a low-duty cycle pattern having an available interval that is not overlapped with available intervals allocated to existing small base stations

2. A condition that the number of users accessed to a certain small base station is rapidly decreased or increased, that is, the number of users accessed to a certain small base station is decreased or increased by a threshold or more

3. A condition that a power saving requirement of a certain small base station is changed

4. A condition that a small base station enters a low-duty mode at a specific time (for example, after midnight) having a power saving requirement that is different from a power saving requirement of other times

The small base station received the change request of the low-duty cycle pattern from the low-duty operation management server updates system information with the received low-duty cycle pattern information (S520). Next, the small base station determines whether there is a terminal in which a change of a sleep cycle is required by the change of the low-duty cycle pattern, from among terminals performing a sleep mode operation (S530). When the change of the sleep cycle is required in a certain terminal, the small base station individually performs a change process of the sleep cycle with the certain terminal (S540). For example, when the available interval of the new low-duty cycle pattern corresponds to a sleep window of the sleep cycle allocated to the certain terminal, the change of the sleep cycle is required in the certain terminal. Next, the small base station applies the changed low-duty cycle pattern (S550), and broadcasts a broadcast message including information about the changed low-duty cycle pattern (S560).

As described above, according to an embodiment of the present invention, a low-duty operation management server can provide a small base station with low-duty cycle pattern information including a length of available interval and a start offset, thereby mitigating interference between a macro base station and the small base station and interference from a neighbor small base station with the minimum overhead, and conserving a power consumption of the small base station. Further, because a low-duty mode operation can be performed even if a terminal in an active state exists in the small base station, the interference can be efficiently mitigated.

Next, a low-duty mode operation managing method according to another embodiment of the present invention is described with reference to Table 4 and Table 5.

Table 4 and Table 5 represent allocation schemes of a low-duty cycle pattern in a low-duty mode operation managing method according to another embodiment of the present invention.

TABLE 4

| | Length | |
|---|---|---|
| Name | (bits) | Description |
| Broadcast Message { | | |
| Length of Available Interval | 2 | Represented as a multiple of |
| | | a basic unit 00:2, 01:4, |
| | | 10:8, 11:16 |
| Start Offset | 2 | Represents a start time of |
| | | the available interval |
| } | | |

Referring to Table 4, a scheme for selecting any value from among predefined values may be used as an allocation scheme of a low-duty cycle pattern. For example, a length of available interval may be not set individually, but may be set by selecting any one value from among the predefined values. For example, 2 bits may be allocated to the length of available interval, and values of “00”, “01”, “10”, and “11” may be set to 2, 4, 8, and 16, respectively. When the length of available interval has the value of “01”, the actual length of available interval is four times of the basic unit.

In this case, the overhead required to notify the low-duty cycle pattern information can be always fixed regardless of the actual lengths of the low-duty cycle pattern, available interval, and unavailable interval. Further, information about the length of available interval can be provided by using fewer bits than the actual length of available interval such that the overhead can be reduced.

TABLE 5

| Index | Parameter Set |
|---|---|
| 1 | Length of Available Interval = a, Length of Unavailable |
| | Interval = aa, Start Offset = aaa |
| 2 | Length of Available Interval = b, Length of Unavailable |
| | Interval = bb, Start Offset = bbb |
| 3 | Length of Available Interval = c, Length of Unavailable |
| | Interval = cc, Start Offset = ccc |
| 4 | Length of Available Interval = d, Length of Unavailable |
| | Interval = dd, Start Offset = ddd |

Referring to Table 5, an index scheme may be used as an allocation scheme of a low-duty cycle pattern. A network operator, for example a low-duty operation management server, predefines low-duty cycle patterns that can be operated in the network, and transmits associated information to terminals and small base stations through a general operation and management operation. Accordingly, the low-duty cycle pattern is allocated and changed by using an index value instead of the low-duty cycle pattern parameter. Since only the index value is transferred to the small base station or terminal for managing the low-duty mode operation, the low-duty mode operation can be managed with the minimum overhead.

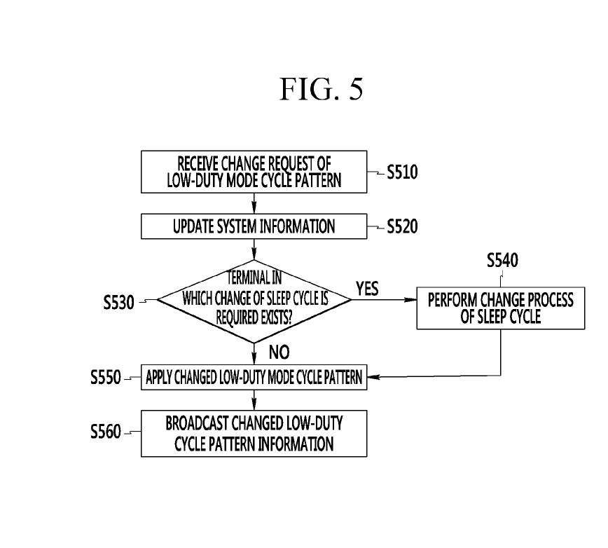

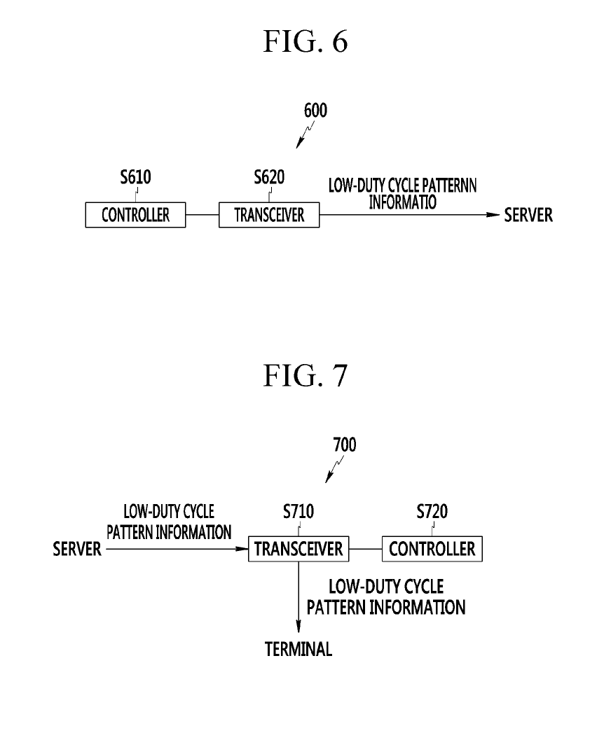

Next, a low-duty mode operation managing apparatus for performing a low-duty mode operation managing method according to an embodiment of the present invention is described with reference to FIG. 6 and FIG. 7.

FIG. 6 and FIG. 7 each is a block diagram showing a low-duty mode operation managing apparatus according to an embodiment of the present invention.

Referring to FIG. 6, a low-duty mode operation managing apparatus 600 includes a controller 610 and a transceiver 620.

The controller 610 determines a low-duty cycle pattern of a small base station that it manages based on information of the small base station, and changes the low-duty cycle pattern set to the small base station when a predetermined condition is satisfied. The transceiver 620 provides information about the determined low-duty cycle pattern or information about the changed low-duty cycle pattern to the small base station.

The low-duty mode operation managing apparatus 600 may be included in a low-duty operation management server, or may be the low-duty operation management server itself.

Referring to FIG. 7, a low-duty mode operation managing apparatus 700 includes a transceiver 710 and a controller 720.

The transceiver 710 receives low-duty cycle pattern information from a low-duty operation management server in accordance with a negotiation with the low-duty operation management server, and transmits its low-duty cycle pattern information to the terminal. The controller 720 determines whether to enter a low-duty mode in accordance with the negotiation with low-duty operation management server, and repeats an available interval and an unavailable interval in accordance with low-duty cycle pattern when entering the low-duty mode.

The low-duty mode operation managing apparatus 700 may be included in a small base station, or may be the small base station itself.

At least part function of a low-duty mode operation managing method or apparatus according to an embodiment of the present invention may be implemented by hardware or software combined with the hardware. For example, a processor such as a central processing unit (CPU), other chipset, or a microprocessor may perform a function of a controller 610 or 720, and a physical transceiver may perform a function of a transceiver 620 or 710.

While this invention has been described in connection with what is presently considered to be practical embodiments, it is to be understood that the invention is not limited to the disclosed embodiments, but, on the contrary, is intended to cover various modifications and equivalent arrangements included within the spirit and scope of the appended claims.

What is claimed is:

1. A method of managing a low-duty mode operation by a small base station, the method comprising:
determining a low-duty cycle pattern in which an available interval for data traffic transmission on active air interface and an unavailable interval for transmitting no data traffic are repeated; and
providing a terminal with low-duty cycle pattern information, the low-duty cycle pattern information including a length of the available interval and a start offset indicating a wireless frame at which the low-duty cycle pattern starts.

2. The method of claim 1, wherein the low-duty cycle pattern starts at the wireless frame satisfying “(wireless frame number) mod (a length of the low-duty cycle pattern)=the start offset”.

3. The method of claim 2, wherein the available interval of the low-duty cycle pattern starts at the wireless frame number.

4. The method of claim 1, wherein the low-duty cycle pattern information further includes the length of the low-duty cycle pattern, and
the length of the low-duty cycle pattern is a sum of the length of the available interval and a length of the unavailable interval.

5. The method of claim 1, wherein the low-duty cycle pattern information further includes a length of the unavailable interval.

6. The method of claim 1, wherein the low-duty cycle pattern information further includes a basic unit, and
the length of the available interval is represented as a multiple of the basic unit.

7. The method of claim 6, wherein the basic unit indicates an exponent when a number of wireless frames is represented as a power of 2.

8. The method of claim 1, further comprising, when the low-duty cycle pattern is changed, broadcasting a message including information about the changed low-duty cycle pattern.

9. A method of managing a low-duty mode operation by a server managing a small base station, the method comprising:
determining a low-duty cycle pattern in which an available interval for data traffic transmission on active air interface and an unavailable interval for transmitting no data traffic are repeated, for the small base station; and
providing the small base station with low-duty cycle pattern information, the low-duty cycle pattern information including a length of the available interval and a start offset indicating a wireless frame at which the low-duty cycle pattern starts.

10. The method of claim 9, wherein the low-duty cycle pattern starts at the wireless frame satisfying “(wireless frame number) mod (a length of the low-duty cycle pattern)=the start offset”.

11. The method of claim 10, wherein the available interval of the low-duty cycle pattern starts at the wireless frame number.

12. The method of claim 9, wherein the low-duty cycle pattern information further includes the length of the low-duty cycle pattern, and
the length of the low-duty cycle pattern is a sum of the length of the available interval and a length of the unavailable interval.

13. The method of claim 9, wherein the low-duty cycle pattern information further includes a length of the unavailable interval.

14. The method of claim 9, wherein the low-duty cycle pattern information further includes a basic unit, and
the length of the available interval is represented as a multiple of the basic unit.

15. The method of claim 14, wherein the basic unit indicates an exponent when a number of wireless frames is represented as a power of 2.

16. The method of claim 9, wherein determining the low-duty cycle pattern includes:
receiving information about neighbor base stations and location information of the small base station from the small base station; and
determining the low-duty cycle pattern based on the information about neighbor base stations and the location information.

17. An apparatus for managing a low-duty mode operation, the apparatus comprising:
a controller configured to determine a low-duty cycle pattern in which an available interval for data traffic transmission on active air interface and an unavailable interval for transmitting no data traffic are repeated; and
a transceiver configured to provide a terminal with low-duty cycle pattern information, the low-duty cycle pattern information including a length of the available interval and a start offset indicating a wireless frame at which the low-duty cycle pattern starts.

18. The apparatus of claim 17, wherein the low-duty cycle pattern starts at the wireless frame satisfying “(wireless frame number) mod (a length of the low-duty cycle pattern)=the start offset”.

19. The apparatus of claim 17, wherein the low-duty cycle pattern information further includes the length of the low-duty cycle pattern, and
the length of the low-duty cycle pattern is a sum of the length of the available interval and a length of the unavailable interval.

20. The apparatus of claim 17, wherein the low-duty cycle pattern information further includes a length of the unavailable interval.
